(19) United States
(12) Patent Application Publication
(10) Pub. No.: US 2011/0320158 A1
(43) Pub. Date: Dec. 29, 2011

(54) METHOD FOR ADJUSTING A MEASURING DEVICE IN PROCESS ANALYSIS TECHNOLOGY

(75) Inventors: Thomas Steckenreiter, Frankfurt (DE); Hans-Peter Roesler, Tubingen (DE)

(73) Assignee: Endress + Hauser Conducts Gesellsschaft fur Mass- und Regeltechnik mbH + Co. KG, Gerlingen (DE)

(21) Appl. No.: 13/166,876

(22) Filed: Jun. 23, 2011

Related U.S. Application Data
(60) Provisional application No. 61/344,293, filed on Jun. 24, 2010.

(30) Foreign Application Priority Data
Jun. 24, 2010 (DE) 10 2010 030 488.3

(51) Int. Cl. G06F 19/00

(52) U.S. Cl. 702/104

(57) ABSTRACT

A method for adjusting a measuring device in process analysis technology, in which the measuring device is arranged remotely from a reference measuring device performing reference measurements, wherein measured values of the measuring device are compared to the reference measured values of the reference measuring device and from this comparison at least one calibration variable for the measuring device is derived. In order be able to perform the adjusting method very rapidly and without interrupting the working process of the measuring device, the measured values of the measuring device and the reference measured values of the reference measuring device are combined in a central data capture and processing software, the calibration value is ascertained by the central data capture and processing software and then the calibration variable is transmitted from the central data capture and processing software to the measuring device for adjusting the measured values.

### CROSS-REFERENCE TO RELATED APPLICATION

This application is a Nonprovisional application which claims the benefit of U.S. Provisional Application No. 61/344,293, which was filed on Jun. 24, 2010.

### TECHNICAL FIELD

The invention relates to a method for adjusting a measuring device in process analysis technology, wherein the measuring device is arranged remotely from a reference measuring device performing reference measurements, wherein measured values of the measuring device are compared to reference measured values of the reference measuring device and from this comparison at least one calibration variable for measured values of the measuring device is derived.

### BACKGROUND DISCUSSION

In process analysis technology, a number of measuring devices are distributed in a process, for example a waste water plant. The measuring devices continuously deliver measurement results to a process control center. These measurement results are, in such cases, stored in the measuring device itself or serve to control the process. Therefore, it is necessary that such measuring devices be newly calibrated or adjusted in certain intervals. For this purpose, samples are taken from the process by a technician and, indeed, at the site where the measuring device to be checked is located. These samples are measured in the laboratory. From the reference measured values ascertained in the laboratory, a calibration variable is determined, with which the measuring device is adjusted on-site.

Especially in the case of use of the measuring devices in wet chemical processes, due to the time required in taking the sample and for the on-site adjustment, such an adjustment by means of a reference value ascertained from a taken sample is omitted, since the measuring device and the laboratory to evaluate the sample are spatially removed from one another. As a substitute, the adjusting occurs using a standard solution, wherein the standard solution is a synthetic, substitute sample. However, real accuracy of measurement of the measuring device is only possible via the reference measurement from a sample taken on-site, since only in this way can matrix effects (i.e. disturbance effects, which are not contained in the standard solutions) of the measured sample be taken into consideration. However, the reference measurement is associated with a high expenditure of time in the field. In such case, the measuring device is also offline for a significant amount of time and is not available for measurements in the process. Moreover, the measured values must be combined with the reference values manually.

### SUMMARY OF THE INVENTION

An object of the invention is thus to provide a method for adjusting a measuring device in process analysis technology, by means of which the measuring device is adjusted rapidly and reliably, wherein the use of technicians in the field is lessened.

According to the invention, the object is achieved by features including that measured values of the measuring device and reference measured values of the reference measuring device are combined in a central data capture and processing software, the calibration value is ascertained by the central data capture and processing software and then the calibration variable is transmitted from the central data capture and data processing software to the measuring device for adjusting the measured values. This has the advantage that the calibration variable after its ascertainment is immediately available to the measuring device for automatic adjusting. In such a case, the measurement operation of the measuring device is not interrupted. This leads to a higher availability of the measuring device. Through the automatic adjusting of the measuring device, the operational safety of the measuring device is increased. A field use of technicians on-site to perform adjustments and calibrations on the measuring device is largely absent in such case.

Advantageously, each measured value of the measuring device is provided with first information concerning the location of the measuring device and the point in time of the measurement. With such information, the measured value of the measuring device is uniquely identified in subsequent evaluation.

In an embodiment, the reference measured value is derived from a sample, which is taken at the site of the measuring device, especially in a wet chemical process, wherein the sample is provided with second information concerning the location of the measuring device and the point in time of the sampling and the reference measured value derived from the sample is likewise characterized by this second information concerning the location of the measuring device and the point in time of the sampling. This site and time information also serves here for the exact association of the reference measured value, especially with measured values, which were transmitted from the measuring device.

In a further development, the measurement data of the measuring device and the reference measured values of the reference measuring device are combined in the central data capture and processing software, wherein the reference measured values are automatically associated with the measured value of the measuring device nearest in time, whereupon the comparison of the reference measured values with this timewise-associated measured value of the measuring device occurs and the calibration variable is ascertained. Since frequently a long time passes between the taking of the sample and the comparison of the measured values of the measuring device with the reference measured values of the reference measuring device derived from the sample, it is of special importance that the data be matched to one another by means of the location and time information. The method permits, consequently, an automatic bringing together of reference and measured values and a centralized determination of the calibration variable, which is forwarded to the measuring device. Lower maintenance costs result therefrom, since the measuring devices arranged on-site can be subjected to centralized and automated maintenance. According to the invention, the method also permits an improved quality assurance, since the data are registered centrally for documentation and the adjustment is automatically documented and performed by means of the real sample.

Especially, the adjusting occurs automatically after transmission of the calibration variable or upon an on-site request. Thus, depending on the measuring device, it can be decided whether the adjusting of the measuring device automatically occurs immediately after the receipt of the calibration variable. This will always be the case especially if the measuring device controls a process with its measurement data. If the measuring device only serves for storing data, it suffices that the adjustment occurs, when requested, for example, through the actuation of a switch on the measuring device.

In a variant, the measurement data of the measuring device are transmitted to the central data capture and processing software and/or the calibration variable is transmitted directly from, or by, the central data capture and processing software to the measuring device for performing adjustment of the current measured values ascertained by the measuring device. The means that all measured values which are determined from the point in time when the calibration variable of the measuring device is known can be corrected with this calibration variable. In such case, it suffices that the calibration variable is made known once to the measuring device, wherein the measuring device evaluates all following measured values with this calibration variable.

In a further development, the measured values of the measuring device, which were ascertained after transmission of the measured values to the central data capture and processing software, are corrected subsequently by means of the calibration variable. In this way, the possible time offset between the ascertaining of the measured values of the measuring device and the determining of the reference measured values in the reference measuring device is reliably overcome.

Advantageously, the central data capture and processing software forms a component of the reference measuring device, preferably a laboratory measuring device, wherein the reference measuring device communicates with the measuring device for performing the calibration. By implementing the central data capture and processing software in the reference measuring device present anyway, the hardware complexity for performing the method is reduced. Thus, there is no need for an additional computer.

Alternatively, the central data capture and processing software forms a component of a personal computer or of a process control computer, wherein the personal computer or the process control computer communicates with the measuring device. Here, also, components already present and necessary for process analysis technology are utilized, in order to accommodate the central data capture and processing software.

The bi-directional communication between the reference measuring device, the personal computer or the process control computer and the measuring device can, in such case, be effected in various ways. Thus, an option is that the communication is effected wirelessly, especially via radio, or electronically via the Internet or via a data bus. The selection of the type of communication depends on the specific process present.

### BRIEF DESCRIPTION OF THE DRAWING

The invention permits numerous forms of embodiment. One thereof will now be explained in greater detail based on the drawing, the sole figure of which shows as follows:

FIG. 1 is a schematic representation of a central data capture with automatic adjustment of the measuring device.

### DETAILED DESCRIPTION IN CONJUNCTION WITH THE DRAWING

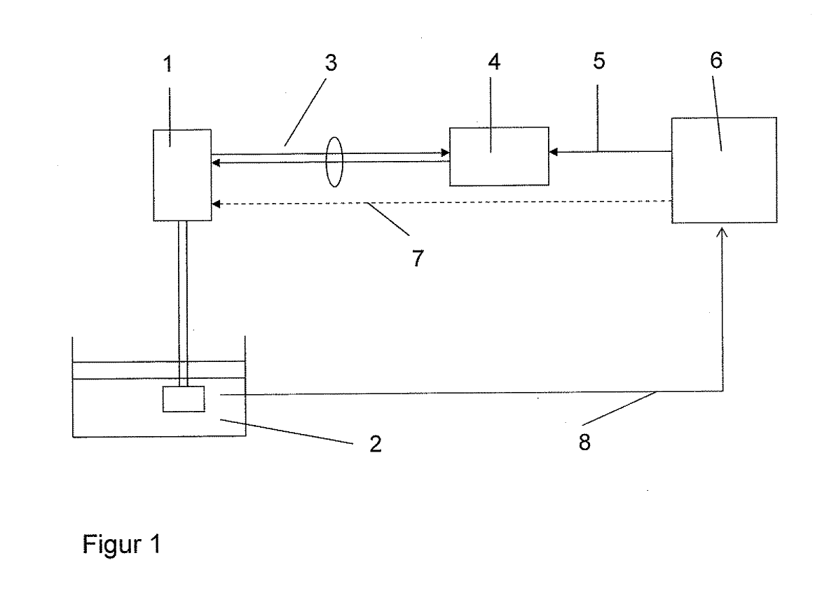

FIG. 1 shows a measuring device 1 embodied, for example, as an analyzer. The analyzer is arranged, in such case, in a wet chemical process 2. The analyzer 1 continuously takes samples from the wet chemical process 2, mixes these with reagents and draws conclusions about the composition of the wet chemical process 2 based on color reactions. The measuring device 1 is connected via a communication line 3 to a central computer 4 which contains a central data capture and processing software. This central computer 4 is connected via a data line 5 to a laboratory measuring device 6. The laboratory measuring device 5 communicates with the measuring device 1 via the communication line 7.

The measuring device 1 is a so-called field device, which can be positioned in the most varied of locations of the wet chemical process 2. The wet chemical process 2 can be, for example, a spatially extended, waste water plant.

The communication line 3 between the central computer 4 and the measuring device 1 is, in such case, embodied bi-directionally. It transmits measurement data from the measuring device 1 to the central computer 4, while the central computer 4 sends calibration variables to the measuring device 1. In such case, a field bus, which, as such, is widely distributed in process analysis technology, is utilized as communication line 3.

For calibrating or adjusting the measuring device 1, a sample is first taken from the wet chemical process 2 and transported by a technician to the laboratory measuring device 6. The sampling is indicated by the arrow 8 in FIG. 1. Then the measured values ascertained by the measuring device 1 are provided with a time and measuring location stamp. With the help of this stamp, the measured value is associated with the measuring device 1, and it is visible accurately at which point in time this measured value was ascertained. The measuring device 1 now actively sends the measured values provided with the time and location stamp to the central data capture and processing software, which is arranged in the central computer 4.

In the laboratory, reference measurements are performed with the laboratory measuring device 6 using the sample which was taken from the wet chemical process 2. The reference measurements so accomplished are likewise provided with a time stamp. Thus, the reference measurements are especially provided with the point in time of the sampling. Moreover, the reference measurement receives additional information in the form of a location stamp, in order to identify uniquely, in the vicinity of which measuring device 1 the sample was taken. The laboratory measuring device 6 likewise transmits these reference measurements via the communication line 5 to the central data capture and processing software in the central computer 4. The central data capture and processing software in the central computer 4 then associates the reference measurements with the measured values which were transmitted from the measuring device 1. In such case, the time and measuring location stamps are utilized for both the reference measurements and the measured values. The central data capture and processing software proceeds, in such case, to associate the reference values with the measured value of the corresponding measuring device 1 nearest in time. After this associating, the central data capture and processing software ascertains a calibration variable between the measured values and the reference values. The thus ascertained calibration variable is transmitted to the measuring device 1 via the communication line 3. The measuring device 1 is automatically adjusted by means of this calibration variable, since a command that the measuring device 1 should execute the adjustment of the measured values is transmitted simultaneously with the supply of the calibration variable.

Due to the possible time lapse between ascertaining the measured values of the measuring device 1 and determining the reference measured values with the laboratory device 6, other measured values of the measuring device 1 can already be present. These measured values are also subsequently corrected automatically based on the adjustment of an older analytical value.

Advantageously, it is also an option, however, that the central data capture and processing software is implemented in the laboratory device 6. In this case, the laboratory device 6 ascertains the calibration variable and sends this to the measuring device 1 via the communication line 7.

The invention permits, thus, an automated method, in which a centralized adjustment of the measuring devices distributed in the field is enabled by the combining of reference and measured values.

1. A method for adjusting a measuring device in process analysis technology, wherein the measuring device is arranged remotely from a reference measuring device performing reference measurements, comprising the steps of:
comparing measured values of the measuring device to reference measured values of the reference measuring device;
deriving from said comparison at least one calibration variable for measured values of the measuring device, wherein measured values of the measuring device and reference measured values of the reference measuring device are combined in a central data capture and processing software;
a calibration value is ascertained by the central data capture and processing software; and
the calibration variable is transmitted from the central data capture and processing software to the measuring device for adjusting the measured values.

2. The method as claimed in claim 1, wherein:
each measured value of the measuring device is provided with first information concerning location of the measuring device and point in time of measuring.

3. The method as claimed in claim 1, wherein:
the reference measured value is derived from a sample taken at the site of the measuring device, especially in a wet chemical process;
the sample is provided with second information concerning location of the measuring device and point in time of sampling; and
the reference measured value derived from the sample is likewise characterized with this second information concerning the location of the measuring device and the point in time of the sampling.

4. The method as claimed in claim 1, wherein:
said measured values of the measuring device and reference measured values of the reference measuring device are combined in the central data capture and processing software; and
the reference measured values are automatically associated with the measured value of the measuring device nearest in time, after which comparison of the reference measured values with this time-associated measured value of the measuring device occurs and the calibration variable is ascertained.

5. The ethod as claimed in claim 4, wherein:
the adjusting occurs automatically after transmission of the calibration variable or upon request

6. The method as claimed in claim 1, wherein:
measurement data of the measuring device are transmitted to the central data capture and processing software and/or the calibration variable is transmitted directly from the central data capture and processing software to the measuring device for performing the adjusting of current measured values ascertained by the measuring device.

7. The method as claimed in claim 4, wherein:
measured values of the measuring device ascertained, in time, after transmission of the measured values to the central data capture and processing software are subsequently corrected by means of the calibration variable.

8. The method as claimed in claim 1, wherein:
the central data capture and processing software is a component of the reference measuring device or, preferably, a laboratory measuring device; and
the reference measuring device communicates with the measuring device for performing the adjusting.

9. The method as claimed in claim 1, wherein:
the central data capture and processing software is a component of a personal computer or a component of a process control computer; and
the personal computer or the process control computer communicates with the measuring device.

10. The method as claimed in claim 8, wherein:
the communication occurs wirelessly, especially via radio, or via the Internet or via a data bus.
